(19) United States
(12) Patent Application Publication
(10) Pub. No.: US 2008/0291815 A1
(43) Pub. Date: Nov. 27, 2008

(54) Topographical surface label formed in an optical disk substrate

(75) Inventor: Jathan D. Edwards, Afton, MN (US)

Correspondence Address: Attention: Eric D. Levinson;Imation Corp., Legal Affairs, P.O. Box 64898, St. Paul, MN, 55164-0898, US

(73) Assignee: Imation Corp.

(21) Appl. No.: 11/805,517

(22) Filed: May 23, 2007

(51) Int. Cl. G11B 3/70

(52) U.S. Cl. 369/283; 264/2.7

(57) ABSTRACT

The disclosure is directed to an optical disk with a topographical surface. The topographical surface may be formed in the optical disk to create an aesthetic label for the optical disk. The topographical surface may include raised features that refract, diffuse, reflect, or diffract light that makes images of the label viewable to a user. The topographical surface may be at least partially radially coincident with a data surface of the optical disk. An optical disk that includes a topographical surface as the label may not require an additional layer or process to create the label. In some examples, the topographical surface may include raised features of high spatial frequency and configured to create a hologram label that displays images to the user.

### TECHNICAL FIELD

The invention relates to data storage media and, more particularly, optical data storage media.

### BACKGROUND

Optical data storage disks have gained widespread acceptance for the storage, distribution and retrieval of large volumes of information. Optical data storage disks include, for example, audio CD (compact disc), CD-R (CD-recordable), CD-RW (CD-rewritable) CD-ROM (CD-read only memory), DVD+/-R (recordable digital versatile disk or digital video disk), DVD-RAM (DVD-random access memory), BluRay, HD-DVD (high definition digital versatile disk), HD-DVD-R (recordable high definition digital versatile disk) and various other types of writable or rewriteable media, such as magneto-optical (MO) disks, phase change optical disks, and others. Optical disk readout devices typically utilize a laser in order to read data stored in the optical disk. Some newer formats for optical data storage disks are progressing toward smaller disk sizes and increased data storage density. For example, BluRay and HD-DVD media formats boast improved track pitches, increased storage through multiple data layers and increased storage density using blue-wavelength lasers for data readout and/or data recording.

Optical storage disks are typically manufactured in multiple steps. These steps may include a step of forming an injection molded substrate, a step of applying one or more thin film sets, and/or a step of applying one or more photoreplicated layers. Spin-replication and/or roll on embossing may be used to add the thin films or photoreplicated layers to the substrate. One or more stampers may be used in these processes to create one or more data surfaces in the substrate or layers of the optical disk. For CD construction disks, the single injection molded substrate includes a data surface side and a blank side through which the laser interrogates the data, e.g., a data access surface. Onto the data access surface, which may include recordable thin films, an incasing sealant coating is applied. For bonded construction disks, such as DVD+/-R or HD-DVD-R, two injection molded substrates are bonded together. Specifically, the data substrate and the blank substrate are bonded together. For cover layer construction disks, such as BluRay, a single injection molded substrate bears the data surface and cover layer on one side while the opposing side is blank, e.g., void of any structure.

Recordable optical disks are typically manufactured to include a label that may provide information and/or decoration for the media product. For example, the label information may identify the media manufacturer, the media supplier, the media type, the media speed, etc. For CD construction disks, the label is typically UV screen printed over the sealant coating on the blank side of the disk that opposes the data access surface of the CD. The UV screen printed layer typically contains a topography of low spatial frequency to refract and/or diffuse the ambient light striking the label surface. The screen resolution may typically limit resolution to less than 150 dots per square inch (dpi). Likewise, for bonded construction disks, the label is typically UV screen printed on the blank substrate side of the bonded disk. For cover layer construction disks, the label is typically UV screen printed on the blank side of the single substrate. In each case, the conventional manufacturing processes include application of an image bearing layer that includes the information and/or decoration as required for the label. Furthermore, each of these cases require that the human readable label is on the blank, e.g., dummy or non-data, side of the finished optical disk.

### SUMMARY

The disclosure is directed to an optical disk with a topographical surface formed on at least one surface of the optical disk wherein the topographical surface labels the optical disk. In one example, the topographical surface may be formed, or stamped, during the injection molding process step for at least one substrate comprising the optical disk. The topographical surface may circumvent the need for an additional layer or manufacturing process step to create the label of the optical disk. In the injection molding process, an inverse topography designed into the stamper or mirror block element of the molding tool is transferred into the (otherwise) blank substrate surface as the topographical surface. In another example, the topographical surface may be formed using a roll embossing or replication process. The roll embossing or replication process may transfer an inverse topography into a blank substrate surface or onto the seal coating surface of a CD construction disk to create the topographical surface that labels the optical disk.

The topographical surface may include features that reflect or diffract light in predetermined patterns that identify and/or decorate the optical disk. The patterns of light reflected from the topographical surface allow images of the label to be viewable to a user. Specifically, the topographical surface may be generally radially coincident to the user recording zone of the optical disk. However, the topographical surface may be viewable from the “back”, or non-data side of the optical disk. As a significant cost savings over the conventional process of printing labels on optical disks, a topographical surface may not require an additional layer of material or process equipment necessary to print the conventional label onto the optical disk.

The topographical surface may be created using a number of techniques. In some examples, an injection molding stamper may be used to form the topographical surface into a surface of the substrate used in the construction of the optical disk. The data surface of the optical disk may be formed into a second substrate of the optical disk, as in the case of DVD or HD-DVD disks. Alternatively, the data surface of the optical disk may be formed into the opposite side of the same substrate having the topographical surface, as in the case of BluRay disks. In other examples, the topographical surface may be formed using spin replication or roll-on embossing onto a seal coating over the data surface, as in the case of CD disks. Other methods may also be used to form the topographical surface that creates the label of the optical disk.

In one embodiment, the invention provides an optical disk that includes a disk-shaped substrate and a topographical surface formed into the disk-shaped substrate that creates a label of the optical disk. The topographical surface is disposed in an outer surface of the optical disk.

In another embodiment, the invention provides a method that includes molding a topographical surface into a disk-shaped substrate of an optical disk with a stamper having an inverse topography. The topographical surface creates a label of the optical disk, and the topographical surface is disposed in an outer surface of the optical disk.

In another embodiment, the invention provides a system for creating optical disk substrates molded with labels that includes a first stamper including an inverse topography, wherein the inverse topography defines a topographical surface that creates the labels in an outer surface of the optical disk substrates during molding processes. The system also includes a second stamper that defines a second surface of the optical disk substrates and a cavity ring that separates the first stamper from the second stamper.

The invention may provide one or more advantages. For example, the topographical surface may create a label for the optical disk using a diverse range of spatial frequencies to provide a diverse range of visual effects to the resultant label. Lower spatial frequencies in the topographical surface may function to provide simple refraction of the ambient lighting striking the topographical surface. Higher spatial frequencies in the topographical surface may function to diffract the light to provide color selectivity or to create holographic image portions of the label. In addition, the method of creating the topographical surface by injection molding into a substrate surface of the optical disk may reduce construction costs and manufacturing time as an additional label material may not need to be added to or printed onto the optical disk.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a conceptual view of an example optical disk with a topographical surface that creates a label of the optical disk.

FIG. 2 is a magnified view of example features which create the topographical surface of the optical disk.

FIGS. 3A and 3B are conceptual views of an example optical disk with a topographical surface that creates holographic images as the label.

FIGS. 4A-4C are cross-sectional views of exemplary optical disks with topographical surfaces.

FIGS. 5A-5C are cross-sectional views of exemplary stampers for creating substrates of optical disks.

FIG. 6 is a cross-sectional view of a spin-replication device for creating a topographical surface on a surface of an optical disk.

FIG. 7 is a flow diagram illustrating an example method for creating an optical disk with a substrate having a topographical surface.

FIG. 8 is a flow diagram illustrating an example method for creating an optical disk with a substrate having a topographical surface and a data surface on opposing sides of the substrate.

FIG. 9 is a flow diagram illustrating an example method for creating an optical disk with a spin-replicated topographical surface.

FIG. 10 is a flow diagram illustrating an example method for creating an optical disk with a roll-on sealcoat layer having a topographical surface.

FIGS. 11A-11C are cross-sectional views of exemplary optical disks with topographical surfaces and volumetric voids.

### DETAILED DESCRIPTION

An optical disk is commonly used to store data and transfer the stored data between computing systems. Since the optical disk is a removable medium, the optical disk includes a factory-applied label, which can identify the optical disk to the user. Generally, the factory applied label includes information such as the manufacturer's logo and/or media type (e.g. 16× DVD-R). Some optical disks are printable optical media which may not include a label or includes a minimal information label at the very inner radius of the disk. The minimal information label may leave a majority of the label surface for the user printable information. The label may include any combination of letters, numbers, colors, images, shapes, symbols, or artwork that either provides information to the user regarding the content of the optical disk or decoration that is aesthetically pleasing. The label may also provide aesthetic features that make the disks more appealing to the eye. Traditionally, the optical disk typically requires that the label be added to an outer surface of the optical disk. A label may be added by applying ink to the optical disk, a thermally applied layer, etching, or any other commonly used technique for changing the outer surface of the optical disk. These methods all include at least one additional manufacturing step that takes place after substrates of the optical disk are created or the entire optical disk is completed, such as applying a print receptive coating and/or a print material that creates the label.

The variations of optical disks described herein generally include a topographical surface to create the factory applied label from a manufacturer created in an outer surface of each of the optical disks. However, users may be able to create or append to the topographical surface in other examples, such as a printable optical media. The topographical surface may eliminate the need to form such labels via the additional label adding step. The topographical surface may create a label for the optical disk using a diverse range of spatial frequencies to provide a diverse range of visual effects presented to a viewer from the label. Lower spatial frequencies in the topographical surface, e.g., less than 150 dots per square inch (dpi) or less than approximately 3 line pairs per millimeter (mm), may function to provide simple refraction of the ambient lighting striking the topographical surface. Higher spatial frequencies in the topographical surface, e.g., up to 2000 line pairs per mm, may function to diffract the light to provide color selectivity or to create holographic image portions of the label.

The topographical surface may be molded or formed into a disk-shaped substrate of the optical disk with a stamper having an inverse topographical surface during the formation of the disk-shaped substrate. The disk shaped substrate formed with the topographical surface may have a blank side or a data surface opposite the topographical surface. Alternatively, the disk shaped substrate with the topographical surface may be bonded to another substrate having a data surface or smooth surface (i.e., a blank or dummy surface). In any case, the topographical surface creates the label for the optical disk with a plurality of raised features, and/or recessed features, in the optical disk. In this manner, time and expense of optical disk manufacture may be reduced by eliminating the need to subsequently print the label on the optical disk. The expense may include material costs of another layer and the capital costs of machines to apply the label to the disk.

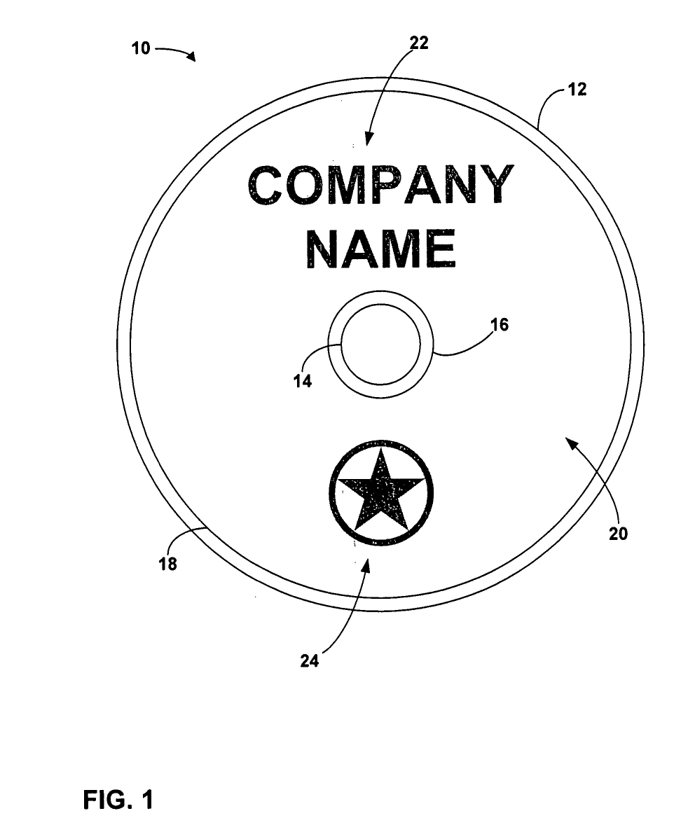

FIG. 1 is a conceptual view of an example optical disk with a topographical surface in a surface of the optical disk. As shown in FIG. 1, optical disk 10 defines outer radius 12 and inner radius 14. The area of optical disk 10 that may include label 20 as defined by the topographical surface (not shown in FIG. 1) resides at least partially between outer radius 18 and inner radius 16. Label 20 may include any combination of letters, numbers, symbols, images, shapes, and artwork. In the example of FIG. 1, label 20 is shown as including words 22 and artwork 24. The opposing surface is a data access surface of optical disk 10 (not shown) allows light to be transmitted to the data surface within the optical disk (not shown).

Optical disk 10 may be any type of optical disk that is configured to store digital data. While optical disk 10 may include data stored on the disk during manufacture, e.g., stamped or formed into a surface of the disk, the disk may not need to store data at all times. For example, optical disk 10 may include a writable or re-writable data surface that a user may modify to store data after the optical disk is manufactured. Optical disk 10 may be manufactured with a blank data surface, or partially blank data surface, in which the user may write data to the disk as needed. These writable or re-writable data surfaces may be constructed using a dye or phase change recording stack of materials that can be modified by a write laser of a compatible disk drive. Therefore, a data surface or data layer, as described herein, may contain data or be configured to contain data at a later time after manufacture.

Label 20 may be formed to all or only a portion of the outer surface of optical disk 10. In other words, the topographical surface is disposed in the outer surface of the optical disk. Label 20 may be located at the same radial position of optical disk 10 with at least a portion of the data surface, e.g., data recording zone, within the optical disk. In other words, label 20 is at least partially coincident and parallel with the data surface that includes the data recording zone, but on the opposing side of the optical disk. Generally, label 20 is located between inner radius 16 and outer radius 18. Label 20 is located in an area of the disk that radially coincides with the data recording zone or data layer at a different depth of optical disk 10. Alternatively, label 20 may be located between inner radius 14 and inner radius 16 and/or between outer radius 12 and outer radius 18 in addition to being located between inner radius 16 and outer radius 18. Therefore, label 20 may be located on an entire surface of optical disk 10 in some examples.

Label 20 may also include any type of text, numbers, images, symbols, or artwork that a manufacturer or user may desire. Optical disk 10 is shown with label 20 that includes words 22 and artwork 24. Words 22 may include the name of the company which is responsible for the data on the disk, the company that manufactured the disk, or even the name of an individual person. In any case, words 22 are an example of information that may identify the data content in optical disk 10. In addition, artwork 24 may include an image that represents the company, which is an example of artwork that identifies the marketing project as being related to real estate. Words 22 and artwork 24 are provided only as an example of label 20, and may include any identifying marks, indicia or design desired by the user.

The topographical surface of optical disk 10 that forms label 20 may cover the entire area between inner radius 16 and outer radius 18 or only a portion of the optical disk surface. The topographical surface may be transparent or opaque as it refracts, diffuses and/or diffracts light to create the features of label 20. The topographical surface creates words 22 and artwork 24 by changing the pattern of light reflected from the outer surface of optical disk 10 through features of the topographical surface. The topographical surface may includes lower spatial frequencies to provide simple refraction of the ambient lighting striking the topographical surface. Alternatively, higher spatial frequencies in the topographical surface may function to diffract the light to provide color selectivity or to create holographic image portions of the label. The topographical surface of optical disk 10 may contain low and high special frequencies throughout label 20, in some examples. The content of label 20 created by the topographical surface may have a primary purpose of identifying the content of data stored on optical disk 10.

Optical disk 10 may be constructed to standard dimensions or custom dimensions, depending upon the intended use of the optical disk. Where optical disk 10 is a CD, DVD, HD-DVD, BluRay, or another similar format, outer radius 12 may be 60 millimeters (mm) and inner radius 14 may be 7.5 mm. In addition, inner radius 16 may be 25 mm while outer radius 18 may be 58 mm. However, optical disk 10 may be constructed with any dimensions desired by the user and readable by a compatible optical disk drive. For example, outer radius 12 may be 40 mm with inner radius 14 being 7.5 mm. Corresponding inner radius 16 may be 25 mm and outer radius 18 may be 38 mm. This example smaller optical disk 10 may be appropriate for applications which require a minimal amount of data storage and extensive distribution of the optical disk.

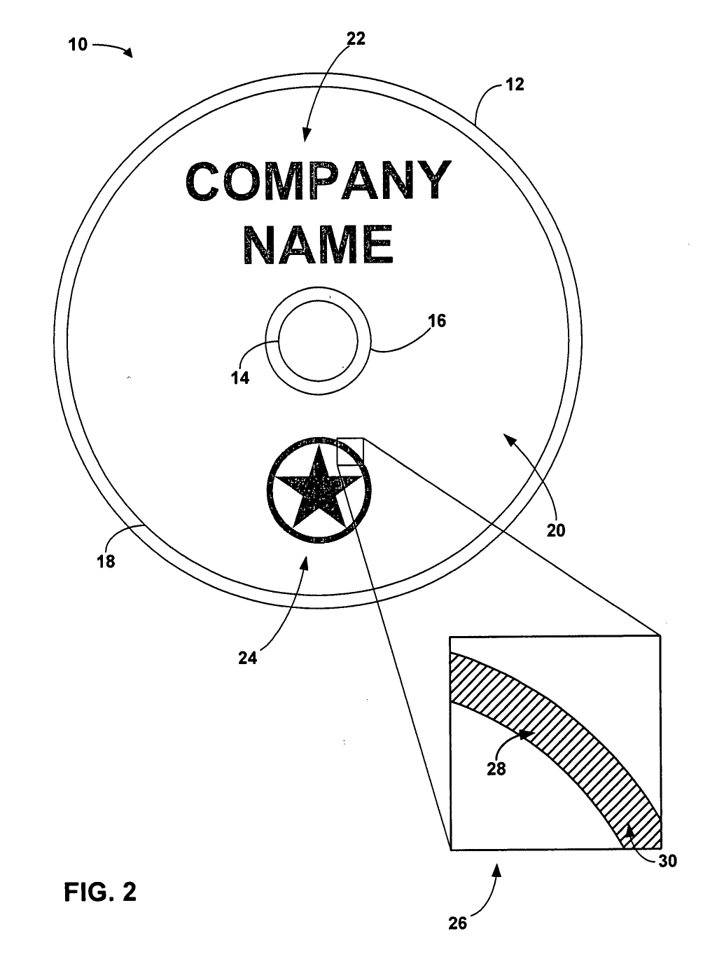

FIG. 2 is a magnified view of example features which create the topographical surface of the optical disk. As shown in FIG. 2, optical disk 10 has an outer diameter 12 and an inner diameter 14. Optical disk 10 also contains label 20 that displays visual information to a user of the optical disk. Label 20 includes words 22 and artwork 24 as example graphics that the label may display as created by topographical surface 26. FIG. 2 also shows a magnified view of artwork 24 of label 20. Topographical surface 26 can be very simply represented in the magnification as including raised features 30 which are separated by depressions 28. Alternatively, the final topographical surface may require a complex waveform rather than a simple grating structure of raised features 30, as shown in FIG. 2.

Topographical surface 26 changes the manner of the appearance of the light reflected from the surface of optical disk 10. The appearance of label 20 may be affected through the spatial frequencies and orientation of grating or refractive raised features 30. When a user views topographical surface 26, features 30 of lower spatial frequency potentially change the angle of refracted light with respect to areas of the surface that do not include raised features. Similarly, when a user views topographical surface 26, raised features 30 of higher spatial frequency (on the order of the wavelength of visible light) potentially change the diffraction of the ambient light striking the surface of optical disk 10. Additionally, areas of topographical surface 26 may include a randomized surface texture useful for creating differing degrees of diffusion of the appearance of label 20. In this manner, raised features 30 display artwork 24 and words 22 to the user because the pattern of light is changed in the areas that include features 30 of topographical surface 26.

As shown in the example representation of FIG. 2, raised features 30 are depicted as equally spaced lines of equal height above depressions 28 within a raised outline of artwork 24 and words 22. It is noted that FIG. 2 represents a simplistic representation of topographical surface 26. Alternatives of topographical surface 26 may include a complex waveform rather than a simple grating structure of raised features 30 and depressions 28. Topographical surface 26 includes depressions 28 between each of the raised features 30 having the same width and depth. In some examples, topographical surface 26 may be formed around words 22 and artwork 24 while the surface of the words and artwork is smooth and lacks the topographical surface. In this manner, words 22 and artwork 24 are defined by the lack of topographical surface 26 or a lack of variation in the topographical surface within words 22 and artwork 24. Alternatively, topographical surface 26 may form words 22 and artwork 24 while another topographical surface having a different pattern than topographical surface 26 is formed over the remaining area of optical disk 10. When label 20 is formed with two or more topographical surfaces, the difference in topographical surface pattern, e.g., the arrangement of raised surfaces, allows the user to identify words 22 and artwork 24 of the label. Differences in raised feature dimensions may also create identifiable differences between two topographical surfaces of label 20.

Although raised features 30 are shown as straight lines filling in words 22 and artwork 24, the raised features may be formed into any shape. For example, raised features 30 may have one or more curves, kinks, or other bends that create a non-straight line. Curved raised features 30 may be similar and nested together or vary in shape while being placed next to each other. In this manner, raised features 30 may be formed and arranged into any type of pattern for topographical surface 26 that creates label 20. As an additional example, raised features 30 may be small circles, triangles, hexagons, or other shapes placed next to each other while depressions 28 are defined as closed circles and the spaces between each circular raised feature.

Raised features 30 also have a cross-sectional shape, which is the shape of each raised feature in a plane orthogonal to the plane of optical disk 10 and the length of the raised feature. As shown in FIG. 2, raised features 30 have a rectangular cross-sectional shape. However, other embodiments of topographical surface 26 may include raised features 30 of other cross-sectional shapes. For example, raised features 30 may have a cross-sectional shape of a triangle, square, or saw tooth as with a blazed grating or other complex shapes. The cross-sectional shape may reflect or refract light differently to create words 22 and artwork 24 of label 20.

For visually diffractive optical effects, e.g., high spatial frequency, features 30 may generally have a width between approximately 0.2 micrometers (μm) and 10 μm. More specifically, raised features may have a width between approximately 0.5 μm and 5 μm. Raised features 30 also generally have a height between approximately 0.1 micrometers (μm) and 10 μm. In some specific examples, raised features may have a height between approximately 0.5 μm and 5 μm. In addition, depressions 28 may have a width between approximately 0.1 μm and 20 μm. More specifically, depressions 28 may have a width between approximately 0.5 μm and 10 μm. Raised features 30 and depressions 28 may have different widths and heights within a single topographical surface 26. In other words, the dimensions of raised features 30 and depressions 28 determine the spatial frequency of topographical surface 26 and the types of images presented to the viewer via label 20.

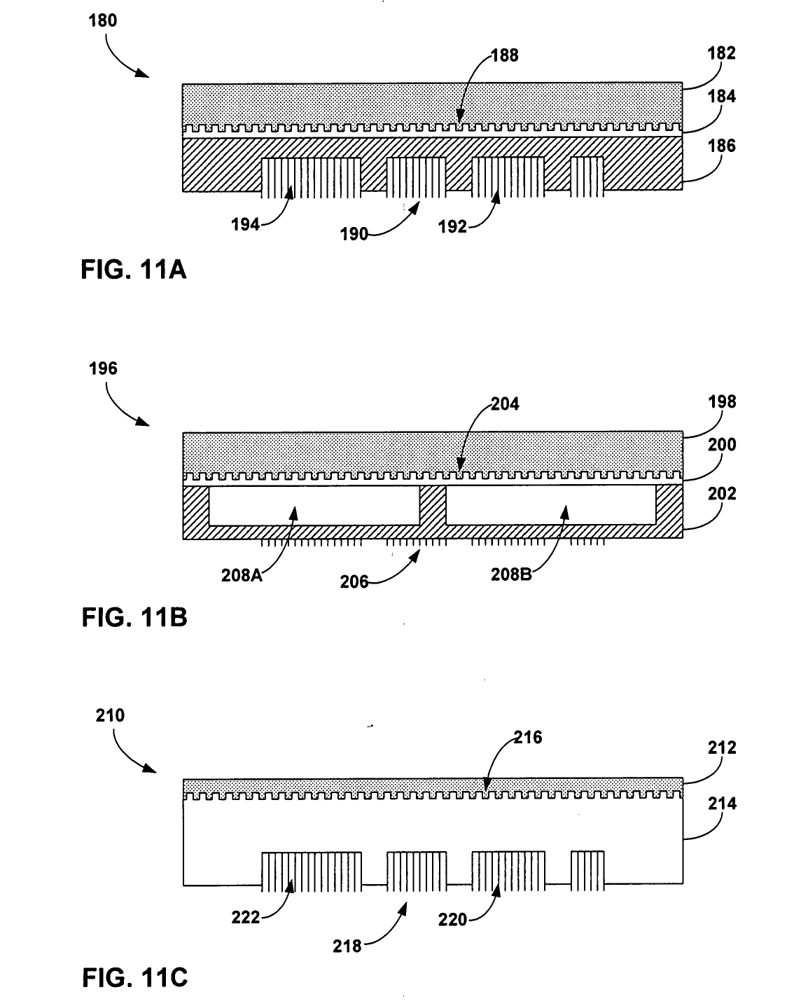

For visually refractive or diffusive optical effects, e.g., low spatial frequency, raised features 30 may have widths as large as the manufacturer or user desires up to the full dimension of the optical media. For examples, raised features 30 may span the full circumference and/or the full radial dimensions of optical disk 10. Furthermore, depression 28 depths may extend to a substantial fraction of the substrate thickness to create volumetric voids in the substrate. Alternatively, volumetric voids may be created in addition to depressions 28. These volumetric voids are further described below in reference to FIGS. 11A-11C.

Additionally, topographical surface 26 may not be formed with raised features 30 only extending from the surface of optical disk 10. Topographical surface 26 may include channels or recesses formed substantially beneath the outermost surface of optical disk 10 in place of raised features 30 which extend from the surface. In this manner, label 20 may be created with many channels or grooves formed as a pattern into optical disk 10 to change the light reflected from the optical disk surface. Alternatively, other examples of label 20 may be created with topographical surface 26 that includes any combination of raised features 30, channels or grooves, and depressions 28. In other words, topographical surface 26 may contain more than two heights and/or two depths to create label 20. Most generally, the manufacturer may create label 20 requiring any complex waveform rather than a simple grating structure of raised features and depressions.

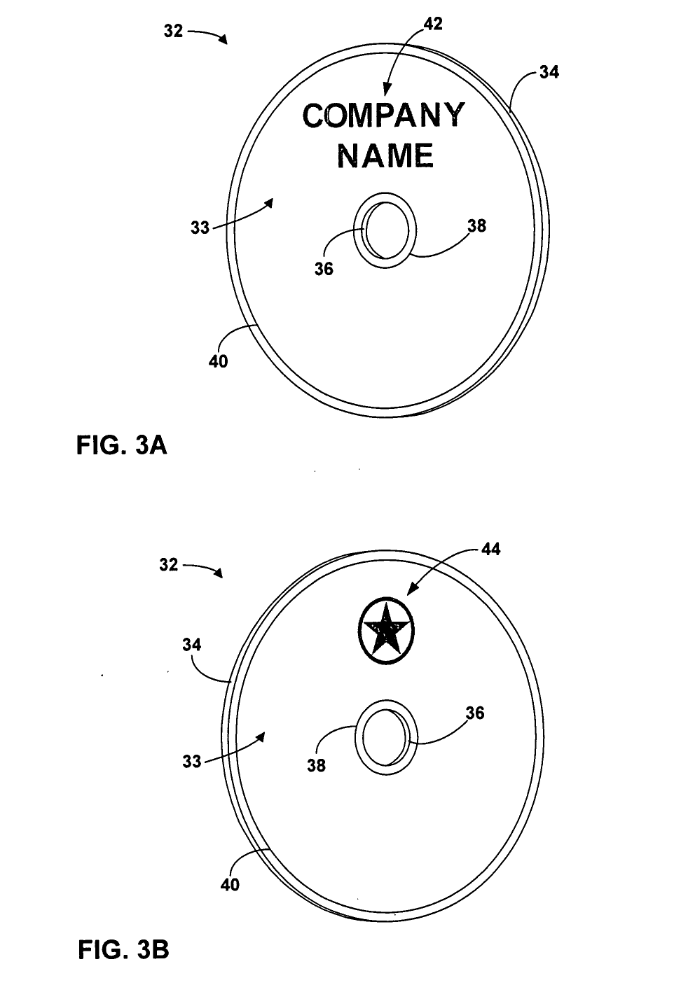

FIGS. 3A and 3B are conceptual views of an example optical disk with a topographical surface that creates color or orientation selective artwork that may be most broadly defined as a holographic image. As shown in FIGS. 3A and 3B, optical disk 32 is similar to optical disk 10, and label 33 is similar to label 20. Optical disk 32 defines outer diameter 34, inner diameter 36, and also defines inner radius 38 and outer radius 40. Label 33 is created by the topographical surface of optical disk 32. The topographical surface may include high spatial frequencies that cause light incident to the surface to be diffracted. Different frequencies or colors of the incident light may be diffracted such that different colors of light are diffracted to different angles. In this manner, label 33 may be designed to provide color selectivity to differing portions of the label image or artwork. Furthermore, different orientations of the incident light relative to the grating segments of the topographical surface may reconstruct differing components of the label artwork. Using such techniques are common for surface relief holograms. The topographical surface of optical disk 32 may be configured to include holographic images that change with respect to the viewing angle of a user to the surface of optical disk 32. Label 33 displays words 42 in the example of FIG. 3A and artwork 44 in the example of FIG. 3B. Label 33 may be configured to display holographic images by arranging the grating segments of the topographical surface such that light is diffracted from the surface as desired by the manufacturer of optical disk 32. In some cases, the cross-section of the features making up the topographical surface may have a complex waveform rather than a simple grating structure in order for the light to be diffracted in the desired manner.

FIG. 3A shows words 42 of label 33 when a user looks at optical disk 32 tilted to the left. In other words, optical disk 32 is tilted so that the user can see the right side of the optical disk and the left side of the optical disk is furthest from the user. The sight line of the user may create an angle with the surface of optical disk 32 that is generally between 0 degrees and 90 degrees. However, words 42 may be best viewed between angles of 30 degrees and 60 degrees. The user may tilt or azimuthally rotate optical disk 32 in order to view alternative images of label 33.

FIG. 3B shows artwork 44 of label 33 when the user looks at optical disk 32 tilted to the right. In other words, optical disk 32 is tilted with respect to the user such that the user can see the left side of the optical disk and the right side of the optical disk is furthest from the user. The sight line of the user creates an angle with the surface of optical disk 32 that is generally between 0 degrees and 90 degrees. More specifically, artwork 44 may be best viewed between the angles of 30 degrees and 60 degrees. In some embodiments, the images of words 42 and artwork 44 may alternative more than 2 times as the user tilts optical disk 32 from one side to the other. For example, the images of label 33 may change with every 60 degrees of tilting optical disk 32. In other examples, the images of label 33 may change with every 30 degrees of tilting optical disk 32. Other examples of label 33 may have varying windows for each angle the images of label 33 are viewable.

In alternative examples, multiple images of label 33 created by the topographical surface may be viewable at the same time. For example, some slight line angles to the optical disk may occur where two angle windows that each show separate images overlap. In other words, a user may view both words 42 and artwork 44 at the same time because the topographical surface reflects light for both images at that particular angle. These sight line angles may occur where words 42 transition into artwork 44 as optical disk 32 is tilted. In other examples, the hologram label 33 may include more than two images. As the user's viewing angle changes with respect to the surface of optical disk 32, label 33 may display three or more images at specific angles for each image. In any case, label 33 may be a hologram that displays multiple images to the user in the same position of optical disk 32, depending on the angle the user views the label.

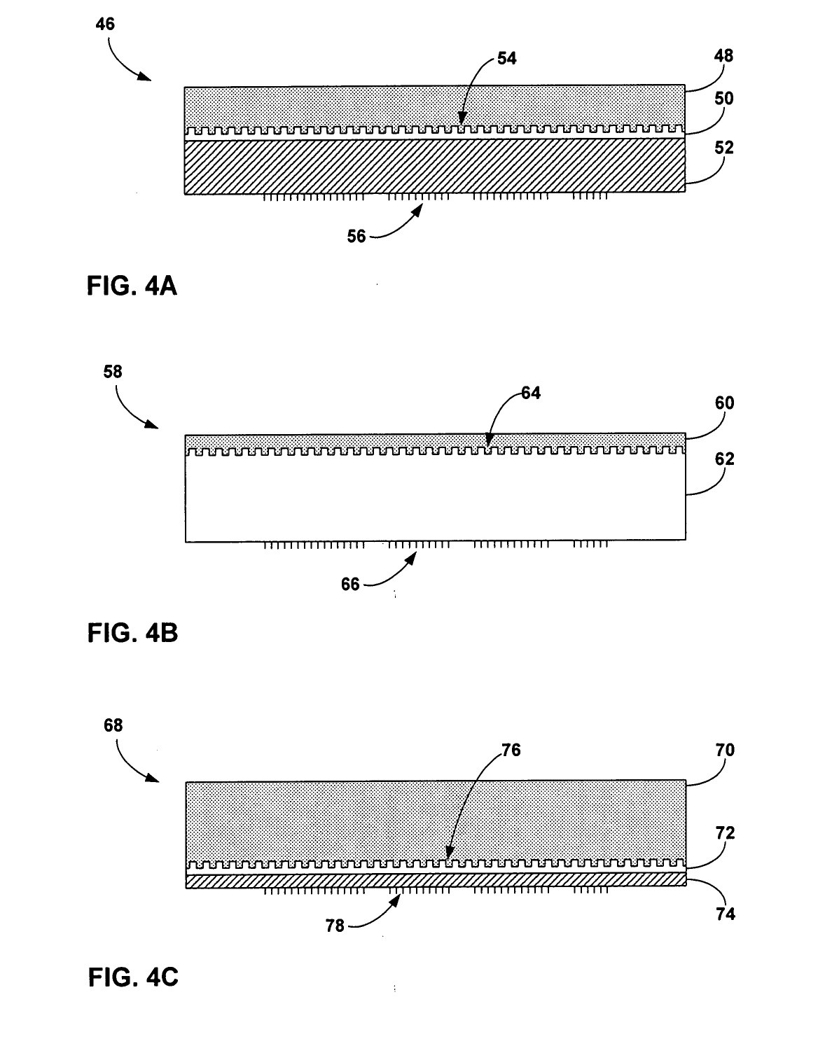

FIGS. 4A-4C are cross-sectional views of exemplary optical disks with topographical surfaces. Optical disks 46, 58, and 68 are embodiments of optical disk 10 of FIG. 1. As shown in FIG. 4A, optical disk 46 includes data substrate 48, thin films 50, and dummy substrate 52, and may be similar to a DVD or HD-DVD format optical disk. Data substrate 48 includes data surface 54 molded into the substrate. Thin films 50 may include a reflective element or diffractive element, and the thin films may bond dummy substrate 52 to data substrate 48. Dummy substrate 52 includes topographical surface 56 formed into the outer surface of the substrate and in the outer surface of optical disk 46. In other words, no material covers topographical surface 56 when optical disk 46 is completed. Topographical surface 56 may be similar to topographical surface 26.

Data is read from data surface 54 through data substrate 48. Therefore, the outer surface of data substrate 48 must be optically transparent for a laser to interrogate data surface 54. The outer surface of dummy substrate 52 may not need to be optically transparent because data surface 54 is not read through dummy substrate 52. Topographical surface 56 may then be formed in dummy substrate 52 to create a label and identify the content of the data stored in optical disk 46. While topographical surface 56 is shown as only covering a portion of the outer surface of dummy substrate 52, some examples of optical disk 46 may have the topographical surface covering the entire outer surface of dummy substrate 52, including at least a portion of topographical surface 56 between the inner and outer radii that includes data surface 54.

Topographical surface 56 may not create a label that includes specific information regarding the data of optical disk 46, in this case. However, topographical surface 56 may still create a label that is unique to the specific optical disk 46. In other examples, topographical surface 56 may be bonded to thin film 50, such that the topographical surface is located within optical disk 46. In this case, substrate 52 may be at least partially transparent to allow the user to view the label created by topographical surface 56.

Alternatively, the data surface may not be located as surface topography in data substrate 48. Thin film 50 may include one or more layers that comprise a dye or phase change recording layer that allows data to be written to the data surface with a laser. In this manner, optical disk 46 may not contain data until after a user records data to the thin film 50.

As shown in FIG. 4B, optical disk 58 includes substrate 62 and thin film 60. Data surface 64 and topographical surface 66 are formed into substrate 62. Thin film 60 covers and protects data surface 64 while remaining at least partially optically transparent to allow a laser to interrogate the data surface. Data surface 64 may include a reflective layer or coating which allows the laser to determine the features within data surface 64. Topographical surface 66 is formed over at least a partial outer surface of substrate 62 in order to create the label of optical disk 58. In other words, no material covers topographical surface 66 when optical disk 58 is completed. Topographical surface 66 may be similar to topographical surface 26. Optical disk 58 may be an example of a BluRay format optical disk.

Alternatively, data surface 64 may not be located as surface topography in substrate 62. An additional data surface layer may be included between substrate 62 and thin film 60. The data surface layer may include a dye or phase change recording layer that allows data to be written to the data surface with a laser. In this manner, optical disk 58 may not contain data until after a user records, or stores, data within the thin film 60. Topographical surface 66 may not create a label that includes specific information regarding the data of optical disk 58, in this case. However, topographical surface 66 may still create a label that is unique to the specific optical disk 46.

FIG. 4C shows optical disk 68 that includes substrate 70, thin films 72, and photoreplicated layer 74. Data surface 76 is formed into substrate 70, while topographical surface 78 is formed into photoreplicated layer 74. A reflective layer may also be added to data surface 76 to allow a laser to read the features of the data surface through the optically transparent substrate 70. Photoreplicated layer 74 may not need to allow light to pass to read data layer 76, so topographical surface 78 is formed to create the label on the outer surface of optical disk 68. In other words, no material covers topographical surface 78 when optical disk 68 is completed. Topographical surface 78 may be similar to topographical surface 26. Optical disk 68 may be in the format of a CD.

Other types of optical disks may be constructed with a topographical surface that creates the label for the optical disk. The topographical surface may be formed on the surface of the optical disk that is not needed for interrogating the data features within the optical disk. However, it may be possible to create a topographical surface that creates the label while also allowing a read laser to pass through the topographical surface to read the data of the data surface. In this manner, it may be possible for an optical disk to have topographical surfaces formed on both outer surfaces of the optical disk as long as a laser is capable of penetrating the topographical surface. In other examples, topographical surface 78 may be bonded to thin films 72, such that the topographical surface is located within optical disk 68. In this case, photoreplicated layer 74 may be at least partially transparent to allow the user to view the label created by topographical surface 78.

In alternative examples of optical disk 68, data surface 76 may not be formed in substrate 70 to allow writable and rewritable operations to the optical disk. Instead, an additional data surface layer may be included between substrate 70 and thin film 72. The data surface layer may include a phase change capability that allows data to be written to the data surface with a laser. In this manner, optical disk 68 may not contain data until after a user writes, or stores, data within the data surface layer. Topographical surface 78 may create a label that is unique to the specific optical disk 68.

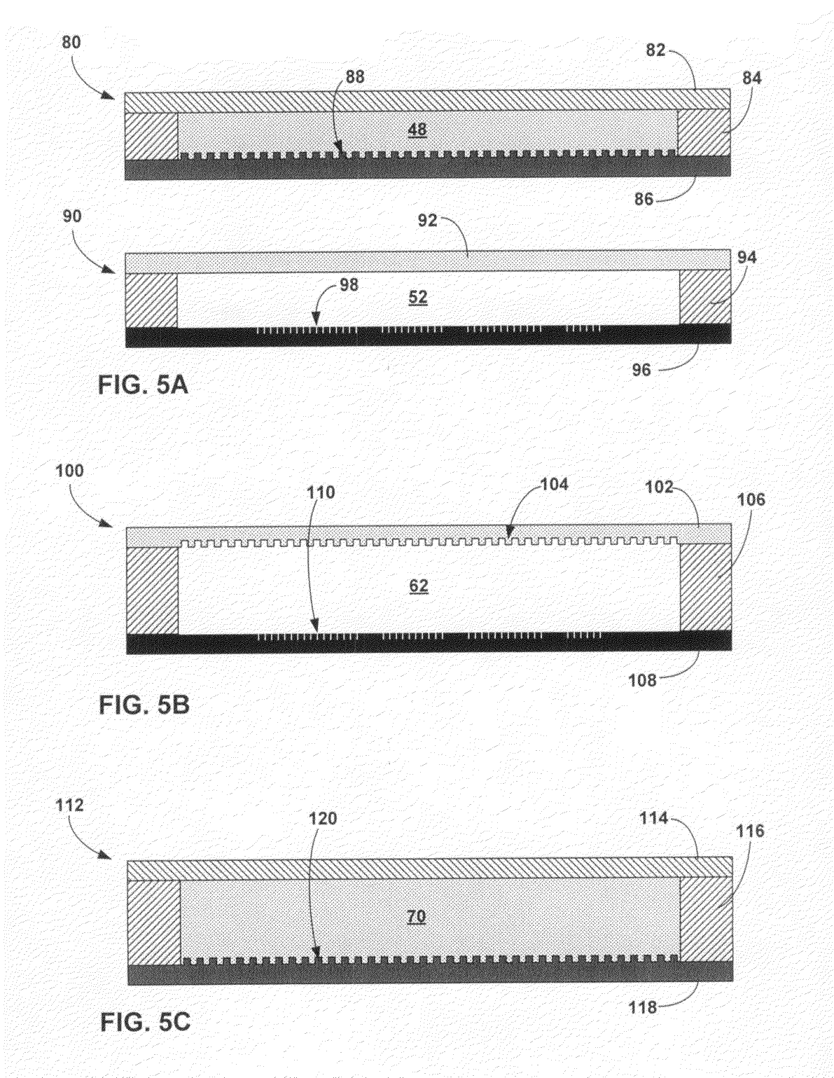

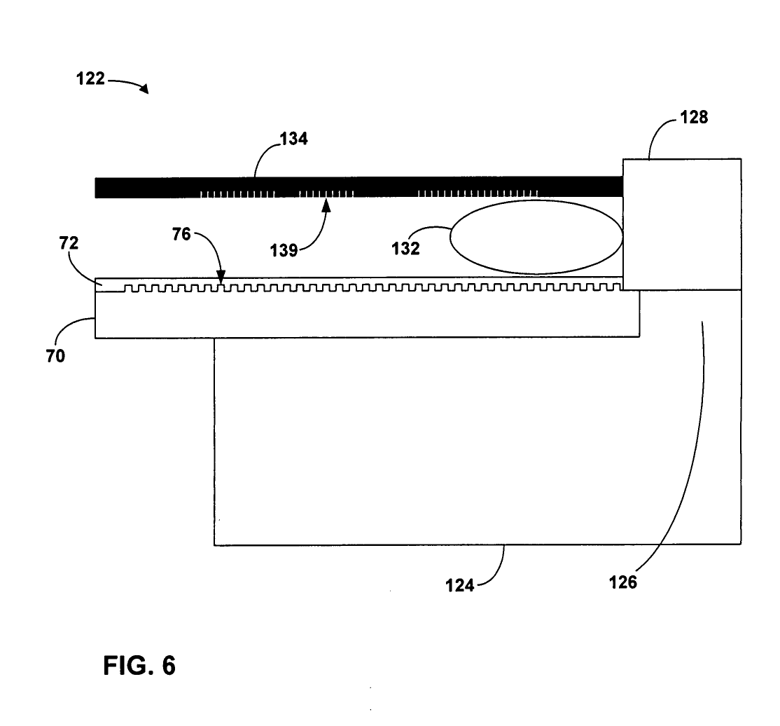

FIGS. 5A-6C are cross-sectional views of an exemplary mold with stampers for creating substrates of optical disks 46, 58, and 68. The substrates described herein may be formed of any type of optically transparent material, such as polycarbonate, amorphous polyolefin, or another optically transparent material. FIGS. 5A-5C provide example techniques for creating substrates of optical disks. Other techniques for injection molding, mold tooling, cover layer bonding, or creating a substrate of an optical disk may also be used in alternative examples. As shown in FIG. 5A, substrates 48 and 52 of optical disk 46 are created through an injection molding process. Mold 80 includes block 82, cavity ring 84, stamper 86, and data substrate 48. Stamper 86 includes an inverse data surface 88 that creates the desired data surface in data substrate 48. Mold 80 may be used to create multiple substrates 48. Mold 80 is put together by placing cavity ring 84 between block 82 and stamper 86. Stamper 86 may be produced from a photo-etched master having features identical to the data surface formed in data substrate 48. In the production process, substrate material, e.g., polycarbonate, is injected into the mold to form data substrate 48. Once data substrate 48 has cooled, mold 80 is opened to remove data substrate 48. Block 82 may comprise another stamper, or a mirror block that includes internal coolant coils to cool the polycarbonate more quickly in the production cycle.

Mold 90 is used to form the second substrate of optical disk 46, dummy substrate 52. Mold 90 includes block 92, cavity ring 94, stamper 96, and dummy substrate 52. Stamper 96 includes an inverse topographical surface 98 that forms the topographical surface within dummy substrate 52. Mold 90 is assembled by placing cavity ring 94 between block 92 and stamper 98. Upon assembly of mold 90, substrate material is injected into the mold to form dummy substrate 52. Dummy substrate 52 is then removed from mold 90 to be assembled with data substrate 48 according to the construction of optical disk 46 described in FIG. 4A. By creating dummy substrate 52 with stamper 96, the topographical surface is formed for optical disk 46 which creates the label for the optical disk without an additional layer or manufacturing step.

FIG. 5B shows mold 100 for creating substrate 62 of optical disk 58. Mold 100 includes stamper 102, cavity ring 104, stamper 106, and substrate 62. Stamper 102 creates the data surface of substrate 62 with inverse data surface 108. Stamper 106 creates the topographical surface of substrate 62 with inverse topographical surface 110. Through the use of stampers 102 and 108, substrate 62 includes a formed topographical surface that creates the label of optical disk 60 without requiring another manufacturing step.

FIG. 5C shows mold 112 that may be used to create substrate 70 of optical disk 68. Mold 112 includes block 114, cavity ring 116, stamper 118, and substrate 70. Stamper 118 includes inverse data surface 120 which creates the data surface of substrate 70. Block 114 provides a smooth surface for the creation of a laser-incident side of substrate 70. In some examples, block 114 may also be considered a stamper. Substrate 70 does not contain the topographical surface of optical disk 68, as an additional layer is later applied to substrate 70 in order to create the topographical surface of optical disk 68, as shown in FIG. 6.

In any of FIGS. 5A-5C, the topographical surface may be formed from a stamper and/or a mirror block. The stamper may be a nickel stamper, e.g., a 300 micron nickel stamper, or a stamper made of another material. Alternatively, the topographical surface may be formed with the mirror block positioned opposite of the stamper. The mirror block may have an inverse topology or pattern that is configured to form the topographical surface as described herein. In this manner, any portion of an injection mold may be used to create the topographical surface.

FIG. 6 is a cross-sectional view of a spin-replication device for creating a topographical surface on a surface of an optical disk. FIG. 6 provides an example technique for creating a topographical surface of an optical disk. Other techniques for cover layer bonding, spin-bonding, mold tooling, or creating a topographical surface of an optical disk may also be used in alternative examples. As shown in FIG. 6, substrate 70 contains data surface 76 that is readable by a laser. Assembly 122 is used to replicate the topographical surface of optical disk 68 and includes disk vacuum chuck 124 and first spindle 126. Second spindle 128 seals substrate 70 from disk vacuum chuck 124. Substrate 70 includes data surface 76 and thin films 72, in which thin films 72 may have been produced with disk assembly 122. Photoreplicated layer material 132 is applied to substrate 70 below stamper 134. Stamper 134 includes inverse topographical surface 139 that creates the topographical surface of optical disk 72 in photoreplicated layer material 132. Stamper 134 allows the photoreplicated layer material 132 to be cured to produce photoreplicated layer 74 with topographical surface 78. In some examples, stamper 134 is flexible to facilitate removal from photoreplicated layer 74.

Substrate 70 defines data surface 76 and thin films 72 which cover the data surface. Thin films 72 allow data surface 76 to be covered in a reflective surface that is needed in order for the data to be read by a laser. In some examples, photoreplicated layer material 132 may be used to cover data surface 76 directly and create the topographical surface in the photoreplicated layer material formed by stamper 134. Disk assembly 122 may be used to create a variety of layers upon substrate 70, based upon the desires of a user. In any event, photoreplicated layer material 132 may be used to create a topographical surface of a completed optical disk 68.

Substrate 70 is center-registered to first spindle 126. First spindle 126 has a diameter smaller than second spindle 128, with exact dimensions that vary based upon the configuration of optical disk 68. For example, first spindle 126 may have a diameter of 15 mm while second spindle 128 may have a diameter of 50 mm. Second spindle 128 is set down over first spindle 126 to secure substrate 70. Second spindle 128 acts as a seal between disk-shaped replica substrate 70 and disk vacuum chuck 124 and the center-registration point for stamper 134. While the diameters of first spindle 126 and second spindle 128 do not have to be as described above, second spindle 128 should be the same diameter as a centering pin used to center stamper 134. Stamper 134 contacts photoreplicated layer material 132 when placed on second spindle 128. Stamper 134 may be greater than or equal to 120 mm in outer diameter with a hole in the center with a diameter equal to thin films 72. The size of stamper 134 may be different is some embodiments, as long as the stamper completely covers thin films 72 of substrate 70.

Photoreplicated layer material 132 is used to create photoreplicated layer 74 with a topographical surface corresponding to inverse topographical surface 139 of stamper 134, where photoreplicated layer material 132 may be created to a desired thickness. Photoreplicated layer material 132 may comprise any material, such as a resin, that can be molded with a stamper. Photoreplicated layer material 132 has a viscosity that allows the final curable material to flow over the surface of thin films 72 when forced towards the outer edge of substrate 70. Photoreplicated layer material 132 may have a viscosity that is determined by the manufacturer to be ideal for the creation of optical disk 68.

Vacuum chuck 124 spins at a high angular speed to force photoreplicated layer material 132 away from second spindle 128. Angular speeds may be between 4000 and 8000 revolutions per minute (rpm), and more ideally at approximately 6000 rpm. As photoreplicated layer material 132 flows outward, thin films 72 of substrate 70 adhere to the outwardly flowing photoreplicated layer material. Spinning may be performed until photoreplicated layer material 132 defines a desired thickness. In this embodiment, photoreplicated layer material 132 is spun until it is between approximately 5 μm and approximately 15 μm thick. In other embodiments, the thickness of photoreplicated layer material 132 may be more or less than this thickness. While the thickness of photoreplicated layer material 132 may slightly vary radially with respect to substrate 70, thickness may be consistent in the circumferential direction. For example, the circumferential thickness variation in one rotation may be less than 2 μm.

Photoreplicated layer material 132 is also curable to form a stable topographical surface that can receive a print material. Curing may be done by numerous methods, but this embodiment describes the use of ultraviolet (UV) light to cure photoreplicated layer material 132 into a hard material, such as photoreplicated layer 74 of optical disk 68. A UV light source directs UV light through stamper 134 to harden and cure photoreplicated layer material 132. In this manner, stamper 134 may allow the transmission of UV energy to photoreplicated layer material 132. Once photoreplicated layer material 132 has cured, stamper 134 may be removed such that optical disk 68 is complete and can be removed from first spindle 126. In some examples, photoreplicated layer material 132 may be cured through other means, such as heat, cold, electrical current, exothermic curing, or any other commonly used method for curing a layer of an optical disk.

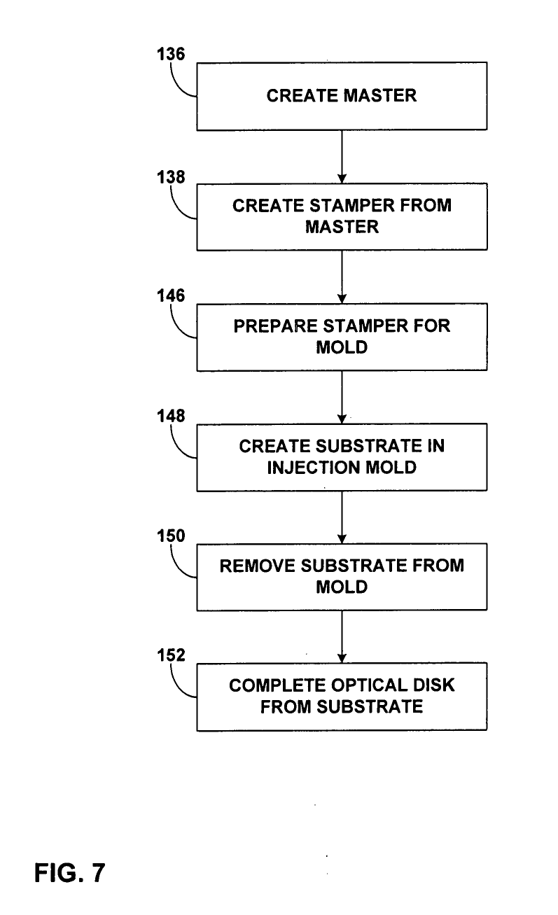

FIG. 7 is a flow diagram illustrating an example method for creating an optical disk with a substrate having a topographical surface. The different steps of FIG. 7 are described as being performed by a user, although some or all of these steps could be automated, e.g., as part of a manufacturing line or molding system. Optical disk 46 will be used as an example, but substrates for optical disks 58 and 68 may also be formed with this method. As shown in FIG. 7, the creation of optical disk 46 begins with a user creating a master that represents topographical surface 56 of the optical disk (136). The user then uses the master to form a stamper having an inverse topographical surface (138).

Once the stamper is created, the user prepares the stamper in a mold 90 (146). The user injects the substrate material into mold 90 that creates dummy substrate 52 having topographical surface 56 on one side of the substrate (148). After dummy substrate 52 is cured, the substrate is removed from mold 92 (150). The user may then complete optical disk 46 by adding any number of layers needed for the use of the optical disk, such as data substrate 48 and thin films 50 (152).

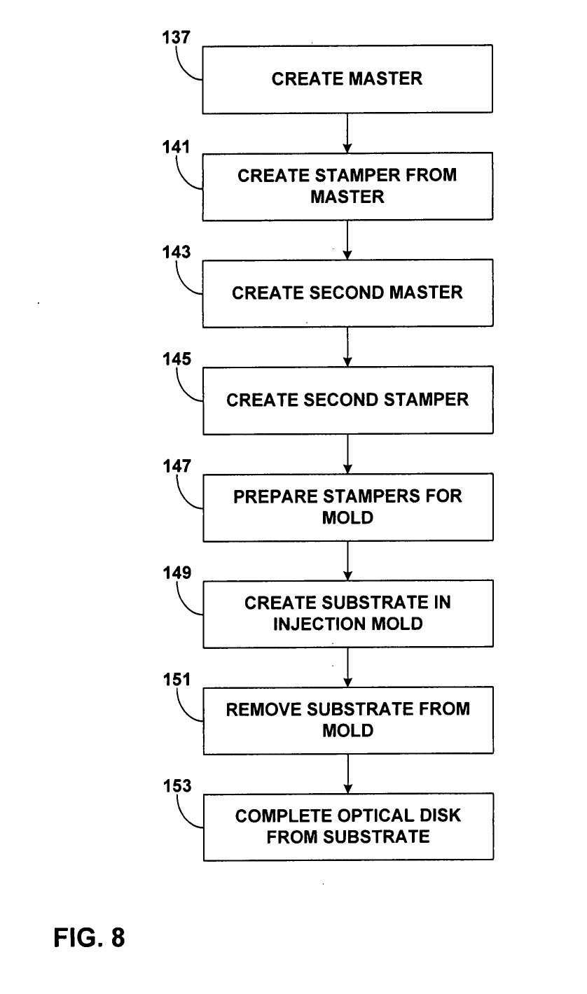

FIG. 8 is a flow diagram illustrating an example method for creating an optical disk with a substrate having a topographical surface and a data surface on opposing sides of the substrate. The different steps of FIG. 8 are described as being performed by a user, although some or all of these steps could be automated, e.g., as part of a manufacturing line or molding system. Optical disk 58 will be used as an example, but other substrates for optical disks may also be formed with this method. As shown in FIG. 8, the creation of optical disk 58 begins with a user creating a master that represents topographical surface 66 of the optical disk (137). The user then uses the master to form a stamper having an inverse topographical surface (141). The user also creates a second master that includes the data surface (143). The user uses the second master stamper to create a second stamper having an inverse data surface (145). The creation of substrates using stampers derived from master stampers is referred to as 2P replication. Stampers are created and used in the injection molding process to create hundreds or even thousands of injection molded substrates. In this manner, multiple stampers may be formed from each master to retain the structure of the master. Alternatively, other methods for forming a data surface or topographical surface in a substrate may also be employed.

Once both stampers are created, the user prepares both stampers in a mold 100 (147). The user injects the substrate material into mold 100 that creates substrate 62 having data surface 64 and topographical surface 66 on opposing sides of the substrate (149). After substrate 62 is cured, the substrate is removed from mold 100 (151). The user may then complete optical disk 58 by adding any number of layers needed for the use of the optical disk (153). For example, the user may add thin film 60 to cover data surface 64.

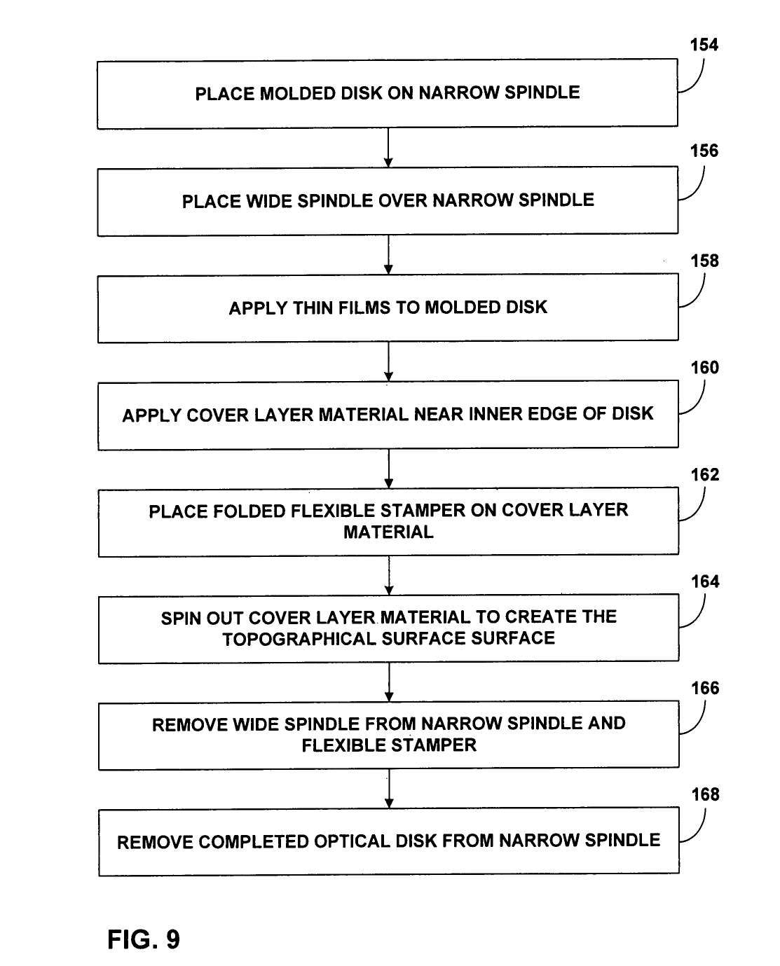

FIG. 9 is a flow diagram illustrating an example method for creating an optical disk with a spin-replicated topographical surface. As shown in FIG. 9, optical disk 68 is finalized after substrate 70 is first produced using a method similar FIG. 7; however, a data surface is formed instead of a topographical surface. A user is described as performing the steps of FIG. 9, but the steps may be automated by a spin-replication device. The user first places substrate 70, e.g., a molded disk, onto narrow spindle 126 (154). The user then places wide spindle 128 over narrow spindle 126 in order to hold substrate 70 in place (156). Once substrate 70 is in place, the user applies thin films 72 to substrate 70 (158).

The user may complete optical disk 68 through the creation of topographical surface 78 in photoreplicated layer 74. The user applies photoreplicated layer material 132 near the inner layer of substrate 70 (160). The user then places stamper 134 on photoreplicated layer material 132 (164) and spins vacuum chuck 124 to spin out or flow photoreplicated layer material 132 between thin films 72 and stamper 134 (164). Once photoreplicated layer material 132 is cured with UV light through stamper 134, the user may remove wide spindle 128 from narrow spindle 126 (166). The user then can remove the completed optical disk 68 from narrow spindle 126 with the label created by topographical surface 78 (168).

The method of FIG. 9 may be used in any application where a thin film, photoreplicated layer, or other coating is applied to an optical disk. After photoreplicated layer 74 is cured, a stiff stamper may be able to be lifted off of topographical surface 78 in some examples. In alternative examples, stamper 134 may be used to create topographical surface 78 without spin replication. Stamper 134 may be applied to a photoreplicated layer material using a roll-on embossing method in which the stamper rolls across a malleable surface to create topographical surface 78. Other methods may also be used to create topographical surface 78 in a layer or material of an optical disk.

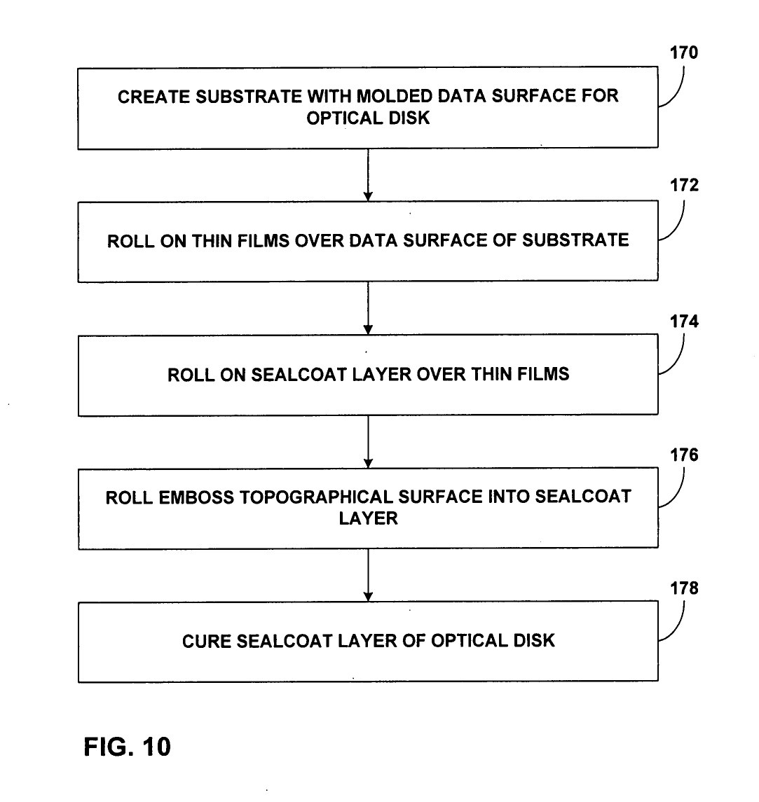

FIG. 10 is a flow diagram illustrating an example method for creating an optical disk with a roll-on sealcoat layer having a topographical surface. The technique of FIG. 10 may be applied to form topographical surface 78 in substrate 74 of optical disk 68. While the technique is described as being performed by a user, the technique may also be automatically or semi-automatically performed by a roll embossing system. The user first creates substrate 70 and data surface 76 using mold 112 (170). The user then rolls on thin films 72 over data surface 76 of substrate 70 (172). Next, the user may roll on a sealcoat layer over the thin films, where the sealcoat layer becomes substrate 74 (174). Before the sealcoat layer solidifies and cures, the user roll embosses the topographical surface 78 into the sealcoat layer with a stamper having an inverse topographical surface (176). The user may then cure the sealcoat layer into substrate 74 of optical disk 68 (178). In the technique of FIG. 10, the stamper may be flexible or formed as a cylinder which can roll over the sealcoat layer. Other methods of forming a topographical surface into a moldable surface may also be used in alternative examples of manufacturing optical disk 68.

FIGS. 11A-11C are cross-sectional views of exemplary optical disks with topographical surfaces and volumetric voids. In general, FIGS. 11A-11C provide for modifications to conventional optical disks to reduce the amount of raw material necessary in the disk construction. More particularly, a portion of a substrate is modified to create one or more substantial volumetric voids compared to a conventional substrate that defines flat parallel surfaces without void areas. The configuration, number, and size of the volumetric voids may be modified in order to substantially reduce inherent raw material cost while maintaining the specified physical thickness, clamping area, and mechanical stability of the medium. These voids and other methods of conserving substrate material may be found in a commonly-assigned and co-pending U.S. patent application Ser. No. 11/507,812 by Jathan Edwards, entitled “RAW MATERIAL CONSERVING OPTICAL DATA STORAGE MEDIA,” which was assigned Attorney Docket No. 10574US01 and filed Aug. 21, 2006, and is incorporated herein by reference in its entirety.

Optical disks 180 and 196 may be similar to optical disk 46 of FIG. 4A, and optical disk 210 may be similar to optical disk 58 of FIG. 4B. However optical disks 180, 196, and 210 may additionally include volumetric voids created to conserve substrate material of the optical disks. FIG. 11A shows optical disk 180 with data substrate 182, thin film 184, and dummy substrate 186. Data substrate 182 includes data surface 188 and dummy substrate 186 includes topographical surface 190. In addition, volumetric voids 194 are created between raised features 192. Volumetric voids 194 may not detract from the appearance of topographical surface 190.

FIG. 11B shows optical disk 196 with data substrate 198, thin film 200, and dummy substrate 202. Data substrate 198 includes data surface 204 and dummy substrate 202 includes topographical surface 206. In addition, volumetric voids 208A and 208B (collectively “volumetric voids 208”) are created in the opposing side of dummy substrate 202 from topographical surface 206. Thin film 200 may be used to bond data substrate 198 to the areas of dummy substrate 202 surrounding volumetric voids 208. Volumetric voids 208 may not detract from the appearance of topographical surface 206 or interfere with the reading or recording of data surface 204. In alternative examples, volumetric voids 194 of optical disk 180 and volumetric voids 208 of optical disk 196 may be provided together in a single substrate.

FIG. 11C shows optical disk 210 with substrate 214 and cover layer 212. Substrate 214 includes data surface 216 on one surface of the substrate and topographical surface 218 on the second side of the substrate. In addition, volumetric voids 222 are created between raised features 220. Volumetric voids 222 may not detract from the appearance of topographical surface 218.

Stampers are described herein as a tool for creating topographical surfaces that can create a label for an optical disk. Stampers include an inverse topographical surface that is a mirror image of the topographical surface to be formed in a layer of the optical disk. The topographical surfaces may be created to display the label as containing one or more images coincident with the data surface of the optical disk. However, stampers are replicated from a master stamper, which includes an identical topographical surface to the topographical surface included in an optical disk. The master stamper may be generated via many different techniques and used to create replicated stampers. These techniques may include inkjet lithography, surface casting of etched diffusive surface, galvanic plating replication, photoresist etching, ashed PMMA texture, or any other method of creating a topographical surface or standoff features. Some of these methods are described below.

Inkjet lithography uses ink droplets to create the topographical surface or standoff features. An example use includes an inkjet printer that prints a randomized array of 10-40 μm droplets onto a disk surface. Droplet size may vary with densities of different colors of ink. An anti-fingerprint surface may be used to form smaller and tighter spheres of ink with the droplets. The ink droplets are then overcoated with a thin metal film, e.g., Ni, Al, or Cr. A film thickness between 5 nanometers (nm) and 20 nm may be formed under vacuum coating. Ink patterned regions are then removed to reveal a metal mask layer with a random array of droplet holes. A plasma ashing process then etches in the disk surface to a depth through the metal mask. Alternative etching methods may include chemical methods to provide more isotropic and more directional etch profiles with a much deeper structure. Once the sublayer etching is completed, the thin film may be cleared with an etchant solution to finalize the master stamper.

In other examples, crystal surface casting may utilize UV replication of a current crystal surface. A crystal surface may be porous with a low density of smaller dimensioned fissures. A metalized or cast surface may be created to form the topographical surface of the master stamper.

In alternative examples, galvanic plating replication uses a controllable texture of a nickel electroplating process that may start with a low current stage for creating stampers from the master stamper. The low current stage may be useful in forming a dense, smooth surface from the master. The remaining thickness of a typical stamper is ramped up to a high-speed plating step. The high-speed plating step may form varying levels of roughness, or topographical surface, on the final surface of the replicated stamper.

Various embodiments of the invention have been described. For example, a topographical surface created on a surface of an optical disk to form a label has been described. The topographical surface may reflect or diffract light in order to produce images identifiable by a user. The techniques of this disclosure can reduce the expense and may provide advantages relative to conventional labels that are printed on the disks. Nevertheless various modifications can be made to the techniques described herein without departing from the spirit and scope of the invention. For example, laser mastering may be used to create a master having a topographical surface. These and other embodiments are within the scope of the following claims.

1. An optical disk comprising:
a disk-shaped substrate; and
a topographical surface formed into the disk-shaped substrate that creates a label of the optical disk, wherein the topographical surface is disposed in an outer surface of the optical disk.

2. The optical disk of claim 1, further comprising a data surface defining an inner radius and an outer radius, wherein at least a portion of the topographical surface is located between the inner radius and the outer radius.

3. The optical disk of claim 2, wherein:
the topographical surface is formed into a first surface of the disk-shaped substrate; and
the data surface is formed into a second surface of the disk-shaped substrate, wherein the first surface opposes the second surface, and wherein the topographical surface is at least partially coincident and parallel with the data surface.

4. The optical disk of claim 2, wherein the data surface is formed into a second disk-shaped substrate.

5. The optical disk of claim 1, wherein the label includes at least one of a letter, a word, a number, a symbol, an artwork, and a holographic image.

6. The optical disk of claim 5, wherein the label displays the at least one of a letter, a word, a number, an image, and a symbol to a viewer at a first angle with respect to the topographical surface and displays at least one of a second letter, a second word, a second number, a second image, and a second symbol to the viewer at a second angle with respect to the topographical surface.

7. The optical disk of claim 1, wherein the topographical surface defines a plurality of raised features which create the label, wherein the plurality of raised features have a width between approximately 0.2 micrometers (μm) and 10 μm and a height between approximately 0.1 micrometers (μm) and 10 μm.

8. The optical disk of claim 1, wherein the topographical surface defines a plurality of raised features which create the label, wherein the plurality of raised features are each separated by a depression between approximately 0.1 micrometers and 20 micrometers in width.

9. The optical disk of claim 1, wherein the topographical surface of the disk-shaped substrate is bonded to a second disk-shaped substrate so that the topographical surface is located within the optical disk.

10. The optical disk of claim 1, further comprising at least one volumetric void formed in the disk-shaped substrate.

11. A method comprising:
molding a topographical surface into a disk-shaped substrate of an optical disk with a stamper having an inverse topography, wherein:
the topographical surface creates a label of the optical disk; and
the topographical surface is disposed in an outer surface of the optical disk.

12. The method of claim 11, further comprising forming a data surface of the optical disk, wherein the data surface defines an inner radius and an outer radius.

13. The method of claim 12, wherein molding the topographical surface further comprises forming at least a portion of the topographical surface between the inner radius and the outer radius.

14. The method of claim 12, wherein:
molding the topographical surface further comprises molding the topographical surface into a first surface of the disk-shaped substrate; and
forming the data surface further comprises forming the data surface into a second surface of the disk-shaped substrate when molding the topographical surface, wherein the first surface opposes the second surface, and wherein the topographical surface is at least partially coincident and parallel with the data surface.

15. The method of claim 12, wherein forming the data surface further comprises forming the data surface into a second disk-shaped substrate.

16. The method of claim 14, further comprising adhering the data surface of the second disk-shaped substrate to a substantially smooth surface opposing the topographical surface of the disk-shaped substrate.

17. The method of claim 12, further comprising forming one or more additional layers over the data surface.

18. The method of claim 11, wherein the inverse topography of the stamper comprises depressions, and wherein molding the topographical surface comprises molding the topographical surface to define a plurality of raised features that create the label, wherein the plurality of raised features are each separated by a depression between approximately 0.1 micrometers and 20 micrometers in width.

19. A system for creating optical disk substrates molded with labels comprising:
a first stamper including an inverse topography, wherein the inverse topography defines a topographical surface that creates the labels in an outer surface of the optical disk substrates during molding processes;
a second stamper that defines a second surface of the optical disk substrates; and
a cavity ring that separates the first stamper from the second stamper.

20. The system of claim 19, wherein the second surface of the second stamper comprises an inverse data surface configured to form a data surface of the optical disk substrates.
